(19) United States
(12) Patent Application Publication
(10) Pub. No.: US 2019/0171263 A1
(43) Pub. Date: Jun. 6, 2019

(54) PROCESSOR COMPUTING POWER AND POWER FOR THERMAL ENERGY MANAGEMENT SOLUTIONS OF A COMPUTING PLATFORM

(71) Applicant: Intel Corporation, Santa Clara, CA (US)

(72) Inventors: Casey R. Winkel, Hillsboro, OR (US); Daniel G. Cartagena, Chandler, AZ (US)

(21) Appl. No.: 16/269,285

(22) Filed: Feb. 6, 2019

Related U.S. Application Data
(60) Provisional application No. 62/749,013, filed on Oct. 22, 2018.

(51) Int. Cl. G06F 1/20; G06F 1/3287; G06F 1/3296

(52) U.S. Cl. CPC G06F 1/206; G06F 2200/201; G06F 1/3296; G06F 1/3287

(57) ABSTRACT

Systems, apparatuses, methods, and computer-readable media, for a computing platform including a controller to manage an amount of power supplied to a processor core. The processor core operates in a first operation mode consuming a first power level, and in a second operation mode consuming a second power level higher than the first power level. The controller is to reduce or cause to be reduced an amount of power supplied to a component of a thermal energy management solution for a time period from a third power level to a fourth power level lower than the third power level, while increasing or causing to be increased an amount of power supplied to the processor core for the processor core to operate in the second operation mode at the second power level during but not exceed the time period. Other embodiments may be described and/or claimed.

### RELATED APPLICATIONS

The present application claims priority under 35 U.S.C. § 119 to U.S. Provisional Application No. 62/749,013 filed on Oct. 22, 2018, the contents of which are hereby incorporated by reference in their entireties.

### FIELD

Embodiments of the present disclosure relate generally to the technical field of computing, including power management for a computing platform, and more particularly to tradeoffs between power for thermal energy management solutions and processor computing power.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

A computing device, system, or platform, may include multiple computing components or modules assembled together with various mechanical support. For example, a container, a cage, or a chassis may be used to house a variety of computing components or modules of computing devices, e.g., processor cores, memory units, and others. A computing component or a module of a computing device or system may generate heat or thermal energy. Sometimes a computing platform, device, or system including multiple computing components placed within a container may be cooled by air generated by one or more fans to remove the thermal energy generated by the computing components. Other thermal energy management solutions, e.g., liquid based cooling solutions, may be used for managing thermal energy generated by the multiple computing components or modules of a computing platform.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIGS. 1(a)-1(b) are diagrams of exemplary computing platforms including a controller to manage an amount of power supplied to a processor core or a component of a thermal energy management solution, in accordance with various embodiments.

FIGS. 2(a)-2(c) are flow diagrams of processes for an exemplary controller of a computing platform to manage an amount of power supplied to a processor core or a component of a thermal energy management solution, in accordance with various embodiments.

FIG. 3 is an example set of performance diagrams showing a tradeoff between amounts of power supplied to a component of a thermal energy management solution and processor cores, in accordance with various embodiments.

FIG. 4 is another example set of performance diagrams showing a tradeoff between amounts of power supplied to a component of a thermal energy management solution and processor cores, in accordance with various embodiments.

FIG. 5 illustrates an example device suitable for use to practice various aspects of the present disclosure, in accordance with various embodiments.

FIG. 6 illustrates a storage medium having instructions for practicing methods described with references to FIGS. 1-5, in accordance with various embodiments.

### DETAILED DESCRIPTION

A computing device, system, or platform, may include multiple computing components or modules, e.g., processors such as servers, processor cores, memory units, or other computing components, assembled together by some mechanical support, e.g., a container, a cage, a rack, or a chassis. For example, in a datacenter, a number of servers or nodes may be placed in a rack, where a slot of the rack may include a server or a node together with some other computing components such as memory units. Each server or node may include one or more processors. Individual processors may be include one or more processor cores. Hereafter, a computing device, system, or platform may be used interchangeably.

A computing component or a module of a computing platform may generate heat or thermal energy. Various thermal energy management solutions, e.g., fans, or liquid based cooling solutions, may be used for managing thermal energy generated by multiple computing components or modules of a computing platform. For example, a liquid based cooling solution may use a liquid coolant inside a heat pipe or a cold plate to dissipate the heat, where the liquid coolant may include water, ammonia, freon, or any other coolant liquid. On the other hand, the thermal energy management solutions, e.g., fans, or liquid based cooling solutions, use power as well. A computing platform may leverage a common redundant power supply (CRPS) to provide power to all system components, including computing components such as processors, and thermal energy management solutions. For example, a computing platform may have CRPS up to 2100W, while processor thermal design power (TDP) for a processor may take about 145W, 205W, or 300W. The various power amounts, e.g., 2100W, 145W, 205W, or 300W, are for examples only, and are not limiting.

In a computing platform, the more power allocated for a processor for computing, more heat or thermal energy may be generated by the processor, which may demand more power for the thermal energy management solutions to dissipate the heat generated by the processor. Hence, when the overall system power supply is fixed, the simultaneous demands for more power by the processor and the thermal energy management solutions may create a conflict between the amounts of power allocated for thermal energy management solutions or processor cores. In the current competitive server system environment, a computer server system may run under a platform-level or system-level power constraint to be allocated to both the processors and the thermal energy management solutions. Various parameters, e.g., running average power limit (RAPL), or maximum allowable instantaneous power (Pmax) over a short time window, e.g., less than 1 ms, may be used to describe the system-level power constraints. In datacenters, it may be a common practice to overprovision the number of servers that can run at maximal allowable power in a rack. However, when datacenter power capacity is limited, or when multiple nodes are near maximal allowable platform power, a system-level power constraint may limit through power capping, the power supplied to some or all nodes. Sometimes, power capping is typically done by limiting processor power and/or memory power.

In embodiments, a processor in a computing system may operate in different modes, e.g., a normal operational mode, or an improved performance mode. A processor operating in an improved performance mode may be referred to as operating in a turbo mode, or simply referred to as central processing unit (CPU) turbo. When a processor operates in a turbo mode or an improved performance mode, the processor may perform operations faster, with higher clock frequency or higher power consumption comparing to the processor operating in a normal operational mode. CPU turbo may represent an opportunistic increase in performance (or frequency) for a processor that is usually short term, e.g., on an order of multiple seconds or less. A processor may operate in a turbo mode when the workload or an application may have such demands. However, a processor may be limited from performing in a turbo mode by total system level power constraints to be allocated to both the processors and the thermal energy management solutions.

In some embodiments, CPU turbo may be performed when both power and thermal headroom on the processor are available. For example, three conditions may be satisfied first before granting turbo mode for a processor. The processor junction temperature, which may be an operating temperature of the processor at a given moment, may be lower than a threshold temperature or processor hot (PROCHOT) temperature that is a throttle limit value before the processor operates in a reduction of performance. In addition, the processor power may be lower than TDP. Furthermore, the system power may be available so the CPU can draw the additional power from the power supplied to the computing system. Hence, it has been difficult to have a processor to operate in a turbo mode while under system power limit constraints when there is no more system power available.

Embodiments herein may operate a processor in a turbo mode while under system power limit constraints when there is no more system power available. In detail, embodiments herein may exploit the thermal capacity of the heatsink/package mass of a computing system to provide a short time window of thermal margin to enable turbo mode for a processor even if the convective thermal energy management solution performs at a lower level with reduced power. For example, by slowing down the fans used in cooling the computing system, the fans may use less power, while the saved power by the fans may be used by a processor to operate in a turbo mode. Hence, embodiments herein provides tradeoffs between amounts of power for thermal energy management solutions and processor computing power of a computing system. When a computing system has a margin, which may be a temperature difference between the junction temperature of the processor and the temperature specification provided for the computing system, the processor may be allowed to operate in a turbo mode by decreasing the performance of thermal energy management solutions to save power for the processor to operate in a turbo mode. As a result, embodiments herein may provide increased performance for a computing system running bursty high performance workloads by trading off powers used for thermal energy management solutions, without using additional power for the computing system to keep the overall power consumption of the computing system within power constraints.

In embodiments, an apparatus for managing computing power of a computing platform may include a controller disposed in the computing platform to manage an amount of power supplied to a processor core of the computing platform. The processor core operates in a selected one of at least a first operation mode consuming a first power level, and in a second operation mode consuming a second power level higher than the first power level. The controller is arranged to reduce or cause to be reduced an amount of power supplied to a component of a thermal energy management solution for a time period from a third power level to a fourth power level lower than the third power level. The controller is also arranged to increase or cause to be increased an amount of power supplied to the processor core for the processor core to operate in the second operation mode at the second power level during but not exceed the time period.

In embodiments, an apparatus for computing includes a printed circuit board (PCB), one or more processor cores disposed on the PCB, and a controller disposed on the PCB and coupled to the one or more processor cores to manage an amount of power supplied to a processor core of the one or more processor cores. The processor core operates in a selected one of at least a first operation mode consuming a first power level, and in a second operation mode consuming a second power level higher than the first power level. The controller is arranged to reduce or cause to be reduced an amount of power supplied to a component of a thermal energy management solution for a time period from a third power level to a fourth power level lower than the third power level. In addition, the controller is arranged to increase or cause to be increased an amount of power supplied to the processor core for the processor core to operate in the second operation mode at the second power level during but not exceed the time period.

In embodiments, one or more non-transitory computer-readable media includes instructions that cause a controller, in response to execution of the instructions by the controller, to perform various operations. For example, the controller is caused to determine a temperature of a processor core of a computing platform to be less than a predetermined threshold temperature. The processor core operates in a selected one of at least a first operation mode consuming a first power level, and in a second operation mode consuming a second power level higher than the first power level to provide more computing power. The controller is further caused to determine the processor core is to operate in the second operation mode, determine whether a power supply of the processor core is less than a threshold power limit. In addition, the controller is caused to reduce or cause to be reduced an amount of power supplied to a component of a thermal energy management solution of the computing platform for a time period from a third power level to a fourth power level lower than the third power level, and increase or cause to be increased an amount of power supplied to the processor core for the processor core to operate in the second operation mode at the second power level during but not exceed the time period.

In some embodiments, the tradeoffs between amounts of power for thermal energy management solutions and processor computing power of a computing system may be accomplished by software or firmware, which may be C code or machine code internal to the processor that may be called CPU Pcode, to control the fan speed according to various control algorithms or mechanisms. The control algorithms or mechanisms may provide a framework on leveraging control signals that a user may implement in their own fans speed control algorithm with no additional platform expense.

In the description to follow, reference is made to the accompanying drawings that form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Operations of various methods may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiments. Various additional operations may be performed and/or described operations may be omitted, split or combined in additional embodiments.

For the purposes of the present disclosure, the phrase “A or B” and “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board such as a motherboard, for example. By way of example and not limitation, “coupled” may mean two or more elements/devices cooperate and/or interact through one or more network linkages such as wired and/or wireless networks. By way of example and not limitation, a computing apparatus may include two or more computing devices “coupled” on a motherboard or by one or more network linkages.

As used hereinafter, including the claims, the term “unit,” “engine,” “module,” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

As used herein, the term “circuitry” refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD), (for example, a field-programmable gate array (FPGA), a programmable logic device (PLD), a complex PLD (CPLD), a high-capacity PLD (HCPLD), a structured ASIC, or a programmable System on Chip (SoC)), digital signal processors (DSPs), etc., that are configured to provide the described functionality. In some embodiments, the circuitry may execute one or more software or firmware programs to provide at least some of the described functionality.

As used herein, the term “processor circuitry” may refer to, is part of, or includes circuitry capable of sequentially and automatically carrying out a sequence of arithmetic or logical operations; recording, storing, and/or transferring digital data. The term “processor circuitry” may refer to one or more application processors, one or more baseband processors, a physical central processing unit (CPU), a general purpose processing unit (GPU), a single-core processor, a processor core, a dual-core processor, a triple-core processor, a quad-core processor, and/or any other device capable of executing or otherwise operating computer-executable instructions, such as program code, software modules, and/or functional processes.

As used herein, the term “interface circuitry” may refer to, is part of, or includes circuitry providing for the exchange of information between two or more components or devices. The term “interface circuitry” may refer to one or more hardware interfaces (for example, buses, input/output (I/O) interfaces, peripheral component interfaces, network interface cards, and/or the like).

As used herein, the term “computer device” may describe any physical hardware device capable of sequentially and automatically carrying out a sequence of arithmetic or logical operations, equipped to record/store data on a machine readable medium, and transmit and receive data from one or more other devices in a communications network. A computer device may be considered synonymous to, and may hereafter be occasionally referred to, as a computer, computing platform, computing device, etc. The term “computer system” may include any type interconnected electronic devices, computer devices, or components thereof. Additionally, the term “computer system” and/or “system” may refer to various components of a computer that are communicatively coupled with one another. Furthermore, the term “computer system” and/or “system” may refer to multiple computer devices and/or multiple computing systems that are communicatively coupled with one another and configured to share computing and/or networking resources. Examples of “computer devices”, “computer systems”, etc. may include cellular phones or smart phones, feature phones, tablet personal computers, wearable computing devices, an autonomous sensors, laptop computers, desktop personal computers, video game consoles, digital media players, handheld messaging devices, personal data assistants, an electronic book readers, augmented reality devices, server computer devices (e.g., stand-alone, rack-mounted, blade, etc.), cloud computing services/systems, network elements, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management Systems (EEMSs), electronic/engine control units (ECUs), vehicle-embedded computer devices (VECDs), autonomous or semi-autonomous driving vehicle (hereinafter, simply ADV) systems, in-vehicle navigation systems, electronic/engine control modules (ECMs), embedded systems, microcontrollers, control modules, engine management systems (EMS), networked or “smart” appliances, machine-type communications (MTC) devices, machine-to-machine (M2M), Internet of Things (IoT) devices, and/or any other like electronic devices. Moreover, the term “vehicle-embedded computer device” may refer to any computer device and/or computer system physically mounted on, built in, or otherwise embedded in a vehicle.

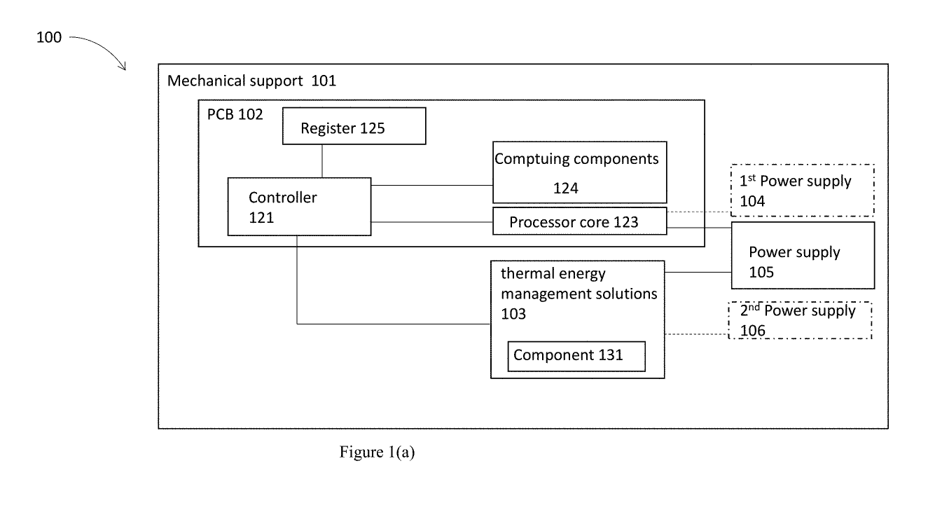

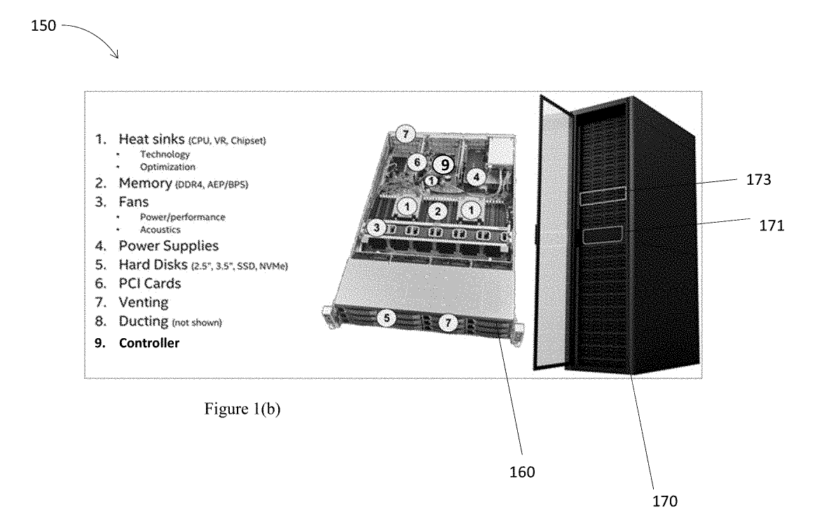

FIGS. 1(a)-1(b) illustrate exemplary computing platforms including a controller to manage an amount of power supplied to a processor core or a component of a thermal energy management solution, in accordance with various embodiments. For example, a computing platform 100 includes a controller 121 to manage an amount of power supplied to a processor core 123 or a component 131 of a thermal energy management solution 103. For clarity, features of the computing platform 100, the controller 121, the processor core 123, the component 131, or the thermal energy management solution 103, may be described below as an example for understanding a computing platform including a controller to manage an amount of power supplied to a processor core or a component of a thermal energy management solution. It is to be understood that there may be more or fewer components included in the computing platform 100, the controller 121, the processor core 123, the component 131, or the thermal energy management solution 103. Further, it is to be understood that one or more of the devices and components within the computing platform 100, the controller 121, the processor core 123, the component 131, or the thermal energy management solution 103, may include additional and/or varying features from the description below, and may include any devices and components that one having ordinary skill in the art would consider and/or refer to as a computing platform including a controller to manage an amount of power supplied to a processor core or a component of a thermal energy management solution.

In embodiments, as illustrated in FIG. 1(a), the computing platform 100 includes the controller 121 to manage an amount of power supplied to the processor core 123 and/or the component 131 of the thermal energy management solution 103. The controller 121 and the processor core 123 are disposed on a printed circuit board (PCB) 102. There may be additional computing components, e.g., a computing component 124, a register 125 disposed on the PCB 102. The computing component 124 may be another processor core, a graphics unit, a memory unit, or other integrated circuit. In some other embodiments, the controller 121 and the processor core 123 may be disposed in different PCBs. There may be more than one PCBs having one or more processor cores and the controller disposed on one of the PCBs or distributed on multiple ones of the PCBs, not shown.

In embodiments, the thermal energy management solution 103 may include one or more components, e.g., the component 131, used for managing thermal energy generated by multiple computing components or modules, e.g., the controller 121 and the processor core 123, of the computing platform 100. The component 131 may be a fan, a heat pipe, or a liquid cooling instrument using coolant selected from water, ammonia, or freon. A mechanical component 101 is used to support or enclose the one or more processor cores, e.g., the processor core 123, the one or more components, e.g., the component 131, of the thermal energy management solution 103, the controller 121, and the one or more printed circuit boards, e.g., the PCB 102. The mechanical component 101 may be selected from a container, a cage, a rack, or a chassis, or any other mechanical component to provide the mechanical support to the PCB 102, the controller 121, the processor core 123, or the component 131 of the thermal energy management solution 103.

In embodiments, the computing platform 100 further includes a common power supply 105 to provide power to the one or more components, e.g., the component 131, of the thermal energy management solution 103, and to provide power to the one or more processor cores, e.g., the processor core 123. In some other embodiments, the computing platform 100 may include a first power supply 104 to provide power to the one or more processor cores, e.g., the processor core 123, and a second power supply 106 to provide power to the one or more components, e.g., the component 131, of the thermal energy management solution 103.

In embodiments, the processor core 123 may operate in at least a first operation mode, a second operation mode, or more different operation modes. The second operation mode of the processor core 123, e.g., a turbo mode, provides improved computational performance for a bursty workload on the processor core 123. Often, the second operation mode may last a limited time period, e.g., in a range of about 1 microsecond to about 10 second. Accordingly, the processor core 123 consumes a first power level in the first operation mode, and consumes a second power level higher than the first power level to provide more improved computational performance in the second operation mode. A power level may be a predetermined amount of power consumption, e.g., a thermal design power. For example, the processor thermal design power for the processor core 123 may be a selected one of 145W, 205W, or 300W, which is a predetermined amount of power consumption for the processor core 123.

In embodiments, the component 131 of the thermal energy management solution 103 may also operate in different power levels. For example, the component 131 may operate in a third power level, or a fourth power level lower than the third power level. When the component 131 is a fan, the component 131 may operate in a third power level when a speed of the fan is higher, and operate in a fourth power level when the speed of the fan is reduced. Similarly, the component 131 may operate in the fourth power level lower than the third power level when an amount of flow of a fluid through the heat pipe, or an amount of flow of the liquid coolant, is reduced.

In embodiments, the controller 121 manages an amount of power supplied to the processor core 123 and an amount of power supplied to the one or more components, e.g., the component 131, of the thermal energy management solution 103. For example, the controller 121 may reduce or cause to reduce the amount of power supplied to the component 131 of the thermal energy management solution 103 for a time period, and increase or cause to be increased an amount of power supplied to the processor core 123 to operate in the second operation mode at the second power level during but not exceed the time period. Accordingly, during the time period, the component 131 of the thermal energy management solution 103 may operate in the fourth power level lower than the third power level, and the processor core 123 may operate in the second operation mode at the second power level higher than the first power level. A sum of the power levels provided to the component of the thermal energy management solution, and to the processor core is below a predetermined power budget. For example, the sum of the first power level to the processor core 123 and the third power level to the component 131 at one time instance, or the sum of the second power level to the processor core 123 and the fourth power level to the component 131 at another time instance are both below a predetermined power budget. In embodiments, the predetermined power budget may be measured by at least one of running average power limit (RAPL), maximum allowable instantaneous power (Pmax), or processor thermal design power (TDP). For example, the computing platform is to operate up to 2100W, and a processor thermal design power for the processor core 123 is 145W, 205W, or 300W. In embodiments, the register 125 may store an indicator to allow or disallow the controller 121 to reduce or cause to reduce the amount of power supplied to the component 131 of the thermal energy management solution 103, and to increase the amount of power supplied to the processor core 123.

In embodiments, before increasing the amount of power supplied to the processor core 123, the controller 121 may determine a temperature of the processor core 123 to be less than a predetermined threshold temperature, determine the processor core 123 is to operate in the second operation mode, and determine a power supply of the processor core 123 is less than a threshold power limit. For example, the controller 121 is to determine the processor core 123 is to operate in the second operation mode, in response to a request from the processor core 123 to operate in the second operation mode. In addition, after the period of time the processor core 123 operating in the second operation mode, the controller 121 may reduce or cause to be reduced the amount of power supplied to the processor core 123, and return the processor core 123 to operate in the first operation mode at the first power level.

In embodiments, there may be many different ways for the controller 121 to reduce the amount of power supplied to the component 131 of the thermal energy management solution 103 for a time period. For example, when the component 131 is an electrical fan, the controller 121 adjusts, based at least in part on a fan control mechanism, a speed of the fan. In detail, the fan control mechanism may include determining a temperature of the processor core 123 to be less than a predetermined threshold temperature, determining a current fan speed of the fan of the thermal energy management solution 103, determining a reduced fan speed to maintain the temperature of the processor core 123 to be less than the predetermined threshold temperature, and decreasing the current fan speed of the fan to the reduced fan speed for the time period during which the amount of power supplied to the fan is reduced, and the amount of power supplied to the processor core 123 is increased. The fan control mechanism may be implemented in various ways, e.g., using a timer. In detail, the fan control mechanism may include monitoring the time period by a timer, monitoring the temperature of the processor core 123 during the time period, and increasing the reduced fan speed to the current fan speed for the fan when the time period expires as indicated by the timer, or the temperature of the processor core exceeds the predetermined threshold temperature.

FIG. 1(b) further illustrates a computing platform 150 including a controller to manage an amount of power supplied to a processor core or a component of a thermal energy management solution. In embodiments, the computing platform 150 may include one or more processors placed within slots of a chassis 170. In detail, the chassis 170 may include a slot 171, a slot 173, or other slots. A node 160 may be placed into the slot 171 or the slot 173. The node 160 may include various heat sinks, e.g., processors or CPUs, virtual reality (VR) chips, or other chipsets, memory units or hard disks, various computing components, e.g., peripheral component interconnect (PCI) cards. The computing platform 150 or the node 160 may also include various mechanical components, e.g., fans, venting, or ducting components. Fans may be shown only as an example for thermal energy management solutions to dissipate heat generated by various computing components, e.g., the heat sinks. Other thermal energy management solutions may be used as well, e.g., heat spreaders, cold plates, heat pipes, and various liquid coolants that may include water, ammonia, freon, or other liquid. The node 160 may further include power supplies, and a controller to manage an amount of power supplied to a processor core or a component of a thermal energy management solution.

The computing platform 150 may be an example of the computing platform 100. In embodiments, the chassis 170 including the slot 171 and the slot 173 may be an example of the mechanical component 101. The various heat sinks, e.g., processors or CPUs, VR chips, or other chipsets, memory units or hard disks, various computing components, e.g., PCI cards, may be examples of the processor core 123. The fans, venting, or ducting components, may be examples of the thermal energy management solution 103. The controller 9 of the computing platform 150 may be an example of the controller 121. The power supply 4 of the computing platform 150 may be an example of the power supply 105. In addition, the computing platform 100 may be implemented in many other ways different from the computing platform 150.

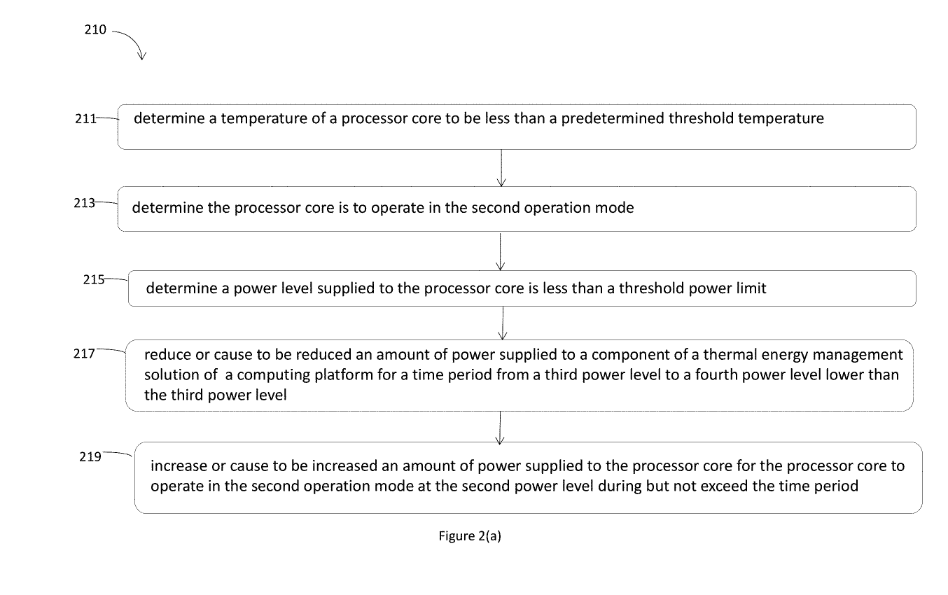

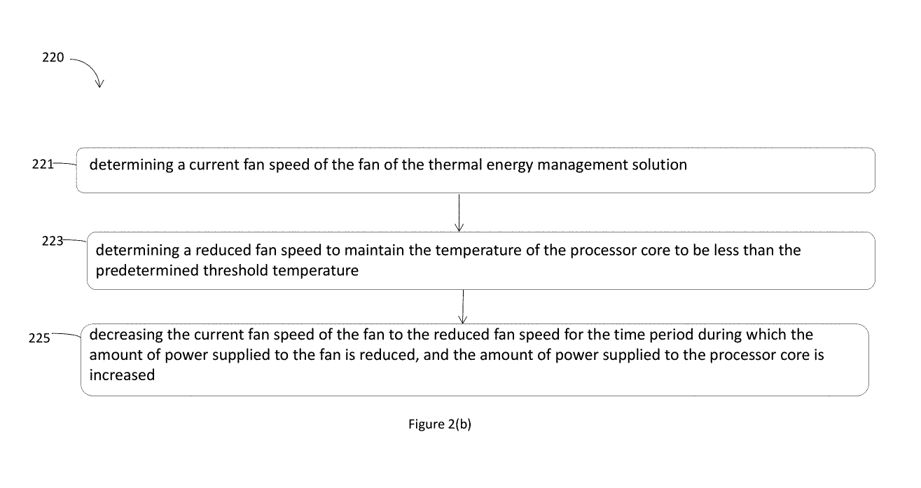

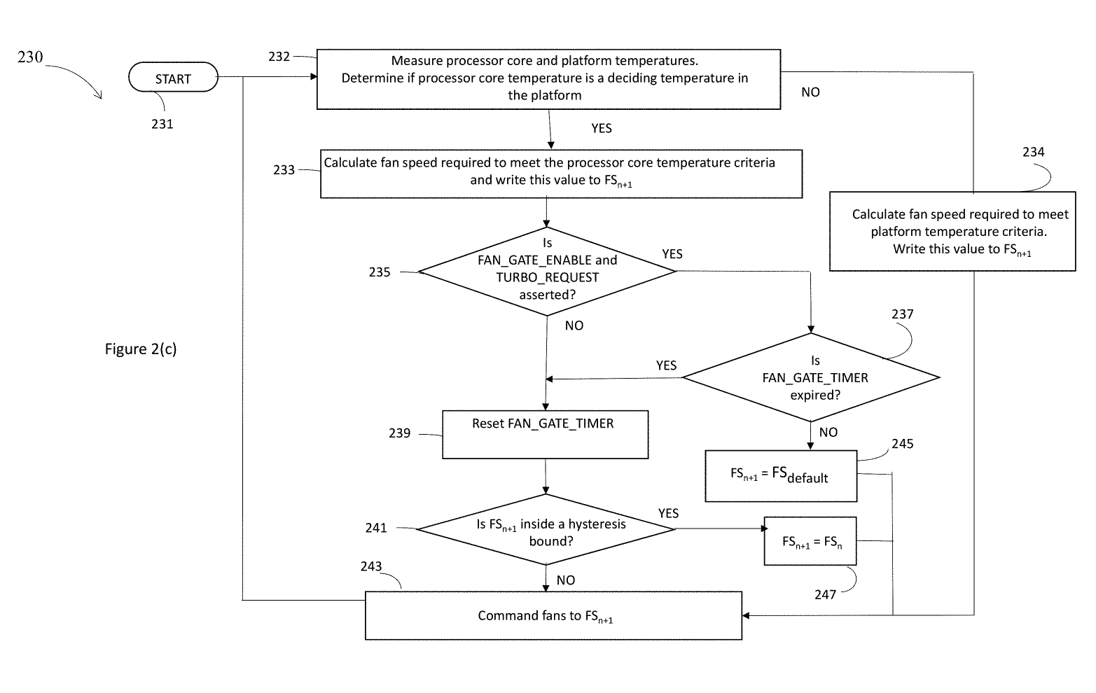

FIGS. 2(a)-2(c) illustrate processes for an exemplary controller of a computing platform to manage an amount of power supplied to a processor core or a component of a thermal energy management solution, in accordance with various embodiments. In embodiments, the processes shown in FIGS. 2(a)-2(c) may be performed e.g., by the controller 121 illustrated in FIG. 1(a), or the controller illustrated in FIG. 1(b).

FIG. 2(a) illustrates an example process 210 to be performed by a controller to manage an amount of power supplied to a processor core or a component of a thermal energy management solution. In embodiments, the process 210 may be performed by the controller 121 to manage an amount of power supplied to the processor core 123 or the component 131 of the thermal energy management solution 103, as shown in FIG. 1(a).

The process 210 may start at an interaction 211. During the interaction 211, operations may be performed to determine a temperature of a processor core to be less than a predetermined threshold temperature. For example, at the interaction 201, operations may be performed by the controller 121 to determine a temperature of the processor core 123 to be less than a predetermined threshold temperature.

During an interaction 213, operations may be performed to determine the processor core is to operate in the second operation mode. For example, at the interaction 203, operations may be performed by the controller 121 to determine the processor core 123 is to operate in the second operation mode, which may provide improved computational performance for a bursty workload on the processor core 123, while consuming higher amount of power than a normal operation mode of the processor core 123.

During an interaction 215, operations may be performed to determine a power level supplied to the processor core is less than a threshold power limit. For example, at the interaction 203, operations may be performed by the controller 121 to determine a power level supplied to the processor core 123 is less than a threshold power limit.

During an interaction 217, operations may be performed to reduce or cause to be reduced an amount of power supplied to a component of a thermal energy management solution of a computing platform for a time period from a third power level to a fourth power level lower than the third power level. For example, at the interaction 203, operations may be performed by the controller 121 to reduce or cause to be reduced an amount of power supplied to the component 131 of the thermal energy management solution 103 of the computing platform 100 for a time period from a third power level to a fourth power level lower than the third power level. When the component 131 is an electrical fan, the controller 121 adjusts or reduces, based at least in part on a fan control mechanism, a speed of the fan. More details of the operations to be performed by the controller 121 to reduce a speed of the fan are illustrated in FIG. 2(b).

In detail, as illustrated in FIG. 2(b), when the component 131 is an electrical fan, the controller 121 adjusts, based at least in part on a fan control mechanism 220, a speed of the fan. The fan control mechanism 220 may include an interaction 221 for determining a current fan speed of the fan of the thermal energy management solution 103, an interaction 223 for determining a reduced fan speed to maintain the temperature of the processor core 123 to be less than the predetermined threshold temperature, and an interaction 225 for decreasing the current fan speed of the fan to the reduced fan speed for the time period during which the amount of power supplied to the fan is reduced, and the amount of power supplied to the processor core 123 is increased.

In addition, the fan control mechanism 220 may include other operations, e.g., monitoring the time period by a timer, monitoring the temperature of the processor core 123 during the time period, and increasing the reduced fan speed to the current fan speed for the fan when the time period expires as indicated by the timer, or the temperature of the processor core exceeds the predetermined threshold temperature.

During an interaction 219, operations may be performed to increase or cause to be increased an amount of power supplied to the processor core for the processor core to operate in the second operation mode at the second power level during but not exceed the time period. For example, at the interaction 219, operations may be performed by the controller 121 to increase or cause to be increased an amount of power supplied to the processor core 123 for the processor core 123 to operate in the second operation mode at the second power level during but not exceed the time period.

FIG. 2(c) illustrates a process 230 for a controller of a computing platform to manage an amount of power supplied to a processor core or a component of a thermal energy management solution, in accordance with various embodiments. The process 230 may be a detailed implementation of the process 210 and the process 220. The process 230 may be performed by the controller 121 to manage an amount of power supplied to the processor core 123 or the component 131 of the thermal energy management solution 103, as shown in FIG. 1(a).

For the process 230, fans are used as examples for thermal energy management solutions. Fan_gate refers to the operation to reduce the fan speed to save power for the computing platform. When the fan speed is reduced to save power, the temperature of the computing platform and/or the temperature of the processor core may increase by some degree. However, as long as the increased temperature is within a tolerable temperature limit, e.g., below a threshold value, and the increased temperature lasts a short time period, the increased temperature may not cause damage to the processor core or the computing platform. At the meantime, the power saved by reducing the fan speed may be used by the processor core to operate in a turbo mode to improve the performance of the computing platform.

For the process 230, FSₙ and FSₙ₊₁ represent current and next fan speed respectively, which may be stored in one or more registers. FS_{default} may be a default fan speed as deemed acceptable to run during the period of time fan speed is gated or reduced. FAN_GATE_TIMER may be set to a maximum amount of time fan speed will be gated. An internal timer may be used to control the fan speed according to a fan control algorithm or mechanism. FAN_GATE_ENABLE may be a variable used to set during boot time per basic input/output system (BIOS) setting (or overwritten through sideband signal) during runtime. This variable may be asserted anytime the feature is desired.

In embodiments, the process 230 may start at an interaction 231. During an interaction 232, operations may be performed to measure or determine a temperature of a processor core (similar to the operations in the interaction 211), measure or determine a temperature of the platform, and further determine if the processor core temperature is a deciding temperature in the platform. If the processor core temperature is a deciding temperature in the platform, the rest of the process 230 may be applicable by a controller of the platform to manage an amount of power supplied to the processor core or the fan. On the other hand, if processor core temperature is not a deciding temperature in the platform, operations may be performed at an interaction 234 to calculate fan speed required to meet platform temperature criteria, and further write the calculated value to FSₙ₊₁. In addition, operations may be performed at an interaction 243 to command the fan to the fan speed FSₙ₊₁.

In embodiments, when the processor core temperature is determined to be a deciding temperature in the platform at the interaction 232, during an interaction 233, operations may be performed to determine or calculate a fan speed FSₙ₊₁ to maintain the temperature of a processor core to be less than the predetermined threshold temperature, (similar to the operations in the interaction 223). During an interaction 235, operations may be performed to determine whether the controller 121 is allowed to reduce or cause to reduce the amount of power supplied to the component of the thermal energy management solution, and to increase the amount of power supplied to the processor core. For example, operations may be performed to check the status or an indicator stored in the register 125 to determine whether the controller 121 is allowed to reduce or cause to reduce the amount of power supplied to the component of the thermal energy management solution. In addition, operations may be performed to determine whether a turbo mode is required (similar to the operations in the interaction 213).

In embodiments, when the controller 121 is not allowed to reduce or cause to reduce the amount of power supplied to the component of the thermal energy management solution, or the processor core 123 does not request a turbo mode, at interaction 239, operations may be performed to reset the FAN_GATE_TIMER to start the timer for monitoring the time period. Optionally, during an interaction 241, operations may be performed to determine whether the FSₙ₊₁ is within a hysteresis bound, which means the difference between FSₙ₊₁ and FSₙ is small enough within a predetermined range, e.g., a hysteresis bound. If the difference between FSₙ₊₁ and FSₙ is small enough within a predetermined range, at interaction 247, operations may be performed to maintain the fan speed FSₙ. During an interaction 243, operations may be performed to change the fan speed to be FSₙ₊₁.

On the other hand, when the controller 121 is allowed to reduce or cause to reduce the amount of power supplied to the component of the thermal energy management solution, and the processor core 123 requests a turbo mode, at the interaction 237, operations may be performed to check whether FAN_GATE_TIMER is expired or not. If the FAN_GATE_TIMER is not expired, during an interaction 245, operations may be performed to set the fan speed FSₙ₊₁=FS_{default}. On the other hand, if the FAN_GATE_TIMER is expired, operations may be moved to the interaction 239 to reset the FAN_GATE_TIMER to start the timer for monitoring the time period, and perform further operations following the interaction 239, e.g., the interaction 241, and the interaction 243.

Operations of the process 230 may be implemented in various ways by hardware, software, or a combination of hardware and software. For example, operations of the process 230 may be implemented by making relatively minor changes to the existing portable code (pcode) and the fan speed control algorithm. For example, a running average power limit (RAPL), or a maximum allowable instantaneous power (Pmax) may be set if applicable to control the power usage of the processor due to system level constraints. RAPL or Pmax may be set this via BIOS option or by change a register value. Another register, e.g., TURBO_REQUEST, may be set by Pcode or other software to request the processor to operate in a turbo mode. TURBO_REQUEST may be asserted anytime when the turbo frequencies are requested but limited by system level power (as denoted by RAPL_FOCUS variable). At boot time of the processor, the fan speed control algorithm may be determined if the operations of the process 230 are to be enabled. Alternatively the operations of the process 230 may be enabled by controllers or registered on a board where the processor is placed.

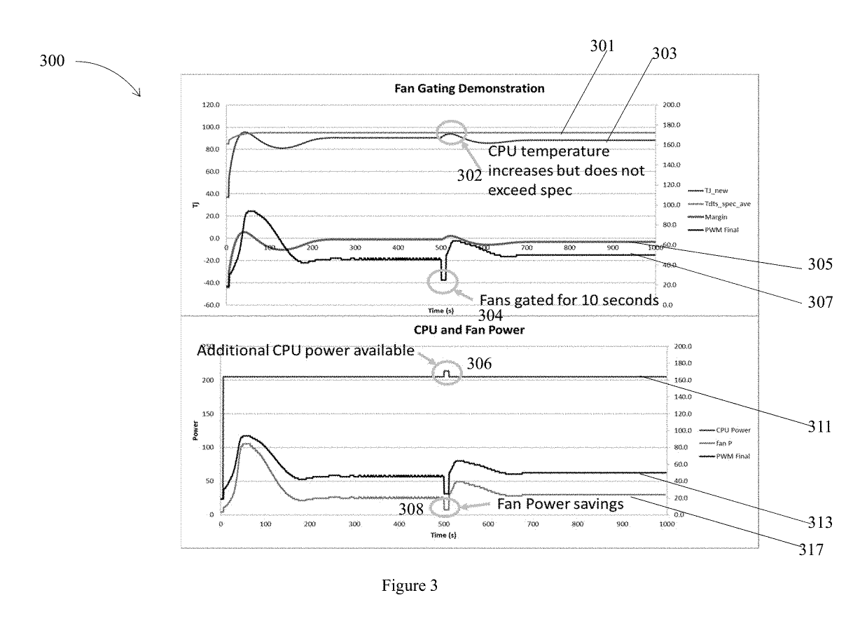

FIG. 3 is an example set of performance diagrams showing a tradeoff between amounts of power supplied to a component of a thermal energy management solution and processor cores, in accordance with various embodiments. The plots in FIG. 3 are generated using a typical fan speed control thermal simulation environment. In detail, the plots show a simulated example of a 205W TDP CPU in a spread core 2 processor (2U) chassis with 6 fans. Ambient temperature is 25C, with a steady state workload at 205W resulting in fans at 45% of max speed.

As shown in FIG. 3, a curve 303 shows the processor junction temperature, which may be an operating temperature of the processor at a given moment. A curve 301 shows a threshold temperature or processor hot (PROCHOT) temperature that is a throttle limit value before the processor operates in a reduction of performance. A curve 305 shows the margin or difference between the curve 303 and the curve 301. In addition, a curve 307 shows the pulse width modulation used to control the input to the fan speed. Furthermore, a curve 311 shows a power level supplied to the processor core, a curve 317 shows a power level supplied to the fans, and a curve 313 shows the pulse width modulation (same as curve 307) used to control the input to the fan speed.

As shown in FIG. 3, at the 500 second point, the fans are gated by to 25% of max speed as shown by point 304 and 308 which results in a power saving of 17W as shown by points 304. The 17W power savings may permit an increase of 8.5W for each CPU of the 2 processors as shown by point 306. This is sufficient power to enable one full bin of turbo on both cores. After 10 seconds, the fan are returned to the nominal 45% speed. As expected, the CPU temperature response demonstrates ˜3 degree rise in temperature, shown at point 302, which is within the tolerance of the thermal specification (e.g.. PROCHOT not tripped).

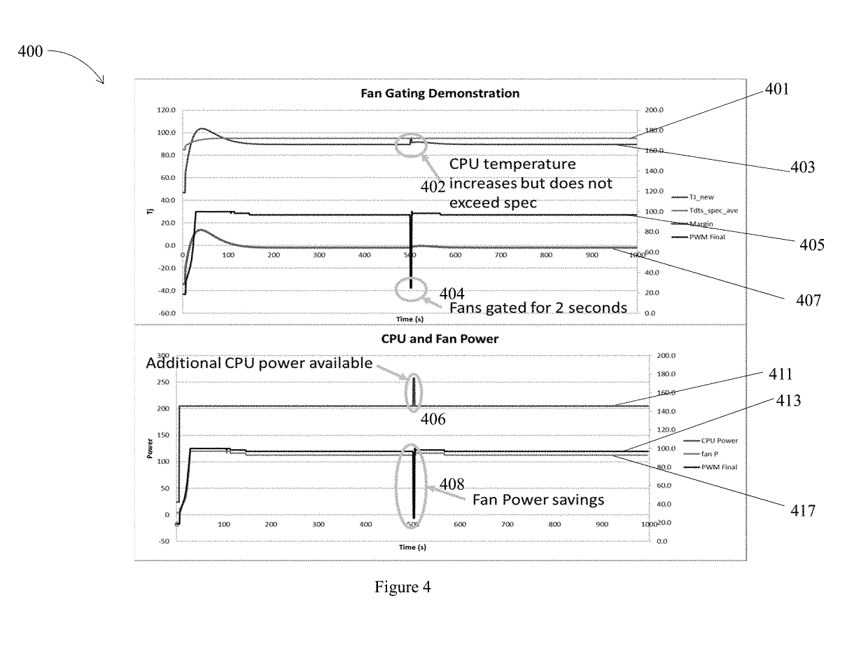

FIG. 4 is another set of example performance diagrams showing a tradeoff between amounts of power supplied to a component of a thermal energy management solution and processor cores, in accordance with various embodiments. In detail, plots in FIG. 4 are simulated where system ambient is 35C and fans are at nearly 100% of max.

As shown in FIG. 4, a curve 403 shows the processor junction temperature, which may be an operating temperature of the processor at a given moment. A curve 401 shows a threshold temperature or processor hot (PROCHOT) temperature that is a throttle limit value before the processor operates in a reduction of performance. A curve 407 shows the margin or difference between the curve 403 and the curve 401. In addition, a curve 405 shows the pulse width modulation used to control the input to the fan speed. Furthermore, a curve 411 shows a power level supplied to the processor core, a curve 417 shows a power level supplied to the fans, and a curve 413 shows the pulse width modulation used to control the input to the fan speed, same as curve 405.

At 500 seconds, the fans are gated for 2 seconds, as shown at point 404, resulting in 100W fan power savings as shown at point 408. This allows each processor a significant amount of power (50W each) as shown at point 406, which is sufficient for 5 bins, e.g., 5 time slots, of frequency. As in the previous example, the CPU temperature rises as shown in point 402, but does not exceed PROCHOT trip point or thermal specification. In typical computation workload, 2 seconds is a long amount of time for the processors to operate in a turbo mode. After the 2 second period, the fans return to their previous speed as does the CPU temperature trend.

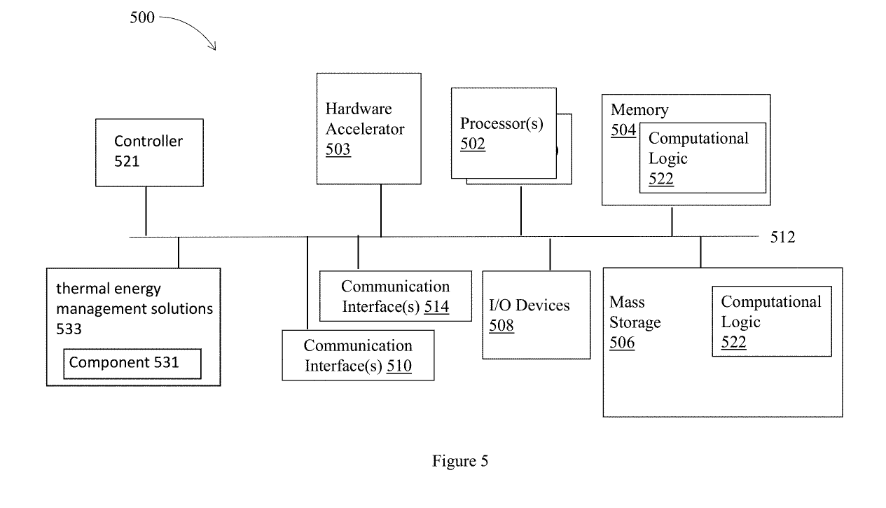

FIG. 5 illustrates an example device 500 that may be suitable as a device to practice selected aspects of the present disclosure. The device 500 may be an example of the computing platforms 100 as shown in FIG. 1.

As shown, the device 500 may include one or more processors 502, each having one or more processor cores, and optionally, a hardware accelerator 503 (which may be an ASIC or a FPGA). In alternate embodiments, the hardware accelerator 503 may be part of processor 502, or integrated together on a SOC. Additionally, the device 500 may include a memory 504, which may be any one of a number of known persistent storage medium, and mass storage 506. Furthermore, the device 500 may include communication interfaces 510 and 514. Communication interfaces 510 and 514 may be any one of a number of known communication interfaces. In addition, the device 500 may include input/output devices 508. In embodiments, one or more (or aspects thereof) of the process 210 shown in FIG. 2(a), the process 220 shown in FIG. 2(b), and the process 230 shown in FIG. 2(c), may be implemented with as part of computational logic 522 disposed in memory 504. In addition, the device 500 may include a controller 521 to execute computational logic 522, a thermal energy management solution 533 that includes at least a component 531. The controller 521, the thermal energy management solution 533, the component 531, and the one or more processors 502 may be similar to the controller 121, the thermal energy management solution 103, the component 131, and the processor core 123, respectively, as shown in FIG. 1(a). The controller 521 is to manage an amount of power supplied to one or more processors 502 or the component 531 of the thermal energy management solution 533. The elements may be coupled to each other via system bus 512, which may represent one or more buses. In the case of multiple buses, they may be bridged by one or more bus bridges (not shown). In alternate embodiments, computational logic 522 executed by controller 521 may be disposed in memory areas/units separated from memory 504 used by processors 502 (and other computing elements).

Each of these elements may perform its conventional functions known in the art. In particular, computational logic 522 stored in system memory 504 and mass storage 505, in the form of a working copy and a permanent copy of programming instructions, in addition to implementing the operations associated with the power control operations of the present disclosure, may also implement an operating system and one or more applications. The computational logic 522 may be implemented by assembler instructions supported by processor(s) 502 or high-level languages, such as, for example, C, that can be compiled into such instructions.

The various elements may be implemented by assembler instructions supported by processor(s) 502 or high-level languages, such as, for example, C, that can be compiled into such instructions. Operations associated with safety operations and configuration of safety operations not implemented in software may be implemented in hardware, e.g., via hardware accelerator 503.

The number, capability and/or capacity of these elements 501-533 may vary, depending on the number of other devices the device 500 is configured to support. Otherwise, the constitutions of elements 501-533 are known, and accordingly will not be further described.

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module,” or “system.”

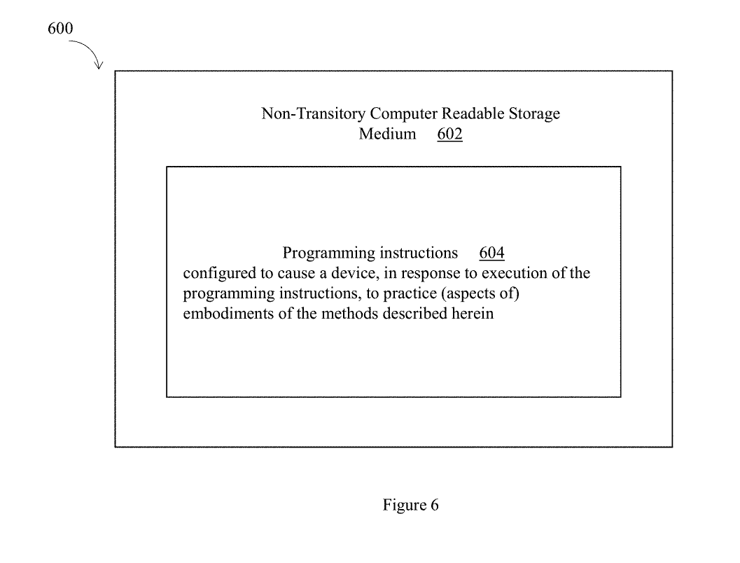

Furthermore, the present disclosure may take the form of a computer program product embodied in any tangible or non-transitory medium of expression having computer-usable program code embodied in the medium. FIG. 6 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 602 may include a number of programming instructions 604. Programming instructions 604 may be configured to enable the controller 521 to manage an amount of power supplied to one or more processors 502 or the component 531 of the thermal energy management solution 533, as shown in FIG. 5, or enable the controller 121 to manage an amount of power supplied to the processor core 123 or the component 131 of the thermal energy management solution 103, as shown in FIG. 1(a).

In alternate embodiments, programming instructions 604 may be disposed on multiple computer-readable non-transitory storage media 602 instead. In alternate embodiments, programming instructions 604 may be disposed on computer-readable transitory storage media 602, such as, signals. Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc..

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions. As used herein, “computer-implemented method” may refer to any method executed by one or more processors, a computer system having one or more processors, a mobile device such as a smartphone (which may include one or more processors), a tablet, a laptop computer, a set-top box, a gaming console, and so forth.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment are chosen and described in order to best explain the principles of the disclosure and the practical application, and to enable others of ordinary skill in the art to understand the disclosure for embodiments with various modifications as are suited to the particular use contemplated.

Thus various example embodiments of the present disclosure have been described including, but are not limited to:

### EXAMPLES

Example 1 may include an apparatus for managing computing power of a computing platform, comprising: a controller disposed in the computing platform to manage an amount of power supplied to a processor core of the computing platform, wherein the processor core operates in a selected one of at least a first operation mode consuming a first power level, and in a second operation mode consuming a second power level higher than the first power level; wherein the controller is arranged to: reduce or cause to be reduced an amount of power supplied to a component of a thermal energy management solution for a time period from a third power level to a fourth power level lower than the third power level, and increase or cause to be increased an amount of power supplied to the processor core for the processor core to operate in the second operation mode at the second power level during but not exceed the time period.

Example 2 may include the apparatus of example 1 and/or some other examples herein, wherein the time period is in a range of about 1 microsecond to about 10 second.

Example 3 may include the apparatus of example 1 and/or some other examples herein, wherein the second operation mode of the processor core provides improved computational performance for a bursty workload on the processor core.

Example 4 may include the apparatus of example 1 and/or some other examples herein, wherein the thermal energy management solution includes a fan, a heat pipe, or a liquid coolant selected from water, ammonia, or freon, and wherein the amount of power supplied to the component of the thermal energy management solution is reduced by reducing a speed of the fan, an amount of flow of a fluid through the heat pipe, or an amount of flow of the liquid coolant.

Example 5 may include the apparatus of example 1 and/or some other examples herein, further comprising: one or more processor cores; and the thermal energy management solution.

Example 6 may include the apparatus of example 1 and/or some other examples herein, further comprising one or more processor cores; one or more components of the thermal energy management solution; one or more printed circuit boards having the one or more processor cores and the controller disposed thereon, and a mechanical component selected from a container, a cage, a rack, or a chassis enclosing the one or more processor cores, the one or more components of the thermal energy management solution, the controller, and the one or more printed circuit boards.

Example 7 may include the apparatus of example 6 and/or some other examples herein, further comprising a common power supply to provide power to the one or more components of the thermal energy management solution, and to provide power to the one or more processor cores.

Example 8 may include the apparatus of example 6 and/or some other examples herein, further comprising a first power supply to provide power to the one or more components of the thermal energy management solution, and a second power supply to provide power to the one or more processor cores.

Example 9 may include the apparatus of example 1 and/or some other examples herein, wherein a sum of the power levels provided to the component of the thermal energy management solution, and to the processor core is below a predetermined power budget, wherein the predetermined power budget is measured by at least one of running average power limit (RAPL), maximum allowable instantaneous power (Pmax), or processor thermal design power (TDP).

Example 10 may include the apparatus of example 1 and/or some other examples herein, wherein the computing platform is to operate up to 2100W, and a processor thermal design power for the processor core is selected one of 145W, 205W, or 300W.

Example 11 may include the apparatus of example 1 and/or some other examples herein, wherein before increasing the amount of power supplied to the processor core, the controller is further to: determine a temperature of the processor core to be less than a predetermined threshold temperature; determine the processor core is to operate in the second operation mode; and determine a power level supplied to the processor core is less than a threshold power limit.

Example 12 may include the apparatus of example 1 and/or some other examples herein, wherein the controller is arranged to further reduce or cause to be reduced the amount of power supplied to the processor core, and return the processor core to operate in the first operation mode at the first power level, after the time period.

Example 13 may include the apparatus of example 1 and/or some other examples herein, wherein the controller is arranged to determine the processor core is to operate in the second operation mode, in response to a request from the processor core to operate in the second operation mode.

Example 14 may include the apparatus of example 1 and/or some other examples herein, further comprising: a register to store an indicator to allow or disallow the controller to reduce or cause to reduce the amount of power supplied to the component of the thermal energy management solution, and to increase the amount of power supplied to the processor core.

Example 15 may include the apparatus of example 1 and/or some other examples herein, wherein to reduce or cause to reduce an amount of power supplied to the component of the thermal energy management solution, the controller adjusts, based at least in part on a fan control mechanism, a speed of a fan of the thermal energy management solution.

Example 16 may include the apparatus of example 15 and/or some other examples herein, wherein the fan control mechanism includes: determining a temperature of the processor core to be less than a predetermined threshold temperature; determining a current fan speed of the fan of the thermal energy management solution; determining a reduced fan speed to maintain the temperature of the processor core to be less than the predetermined threshold temperature; and decreasing the current fan speed of the fan to the reduced fan speed for the time period during which the amount of power supplied to the fan is reduced, and the amount of power supplied to the processor core is increased.

Example 17 may include the apparatus of example 16 and/or some other examples herein, wherein the fan control mechanism further includes: monitoring the time period by a timer; monitoring the temperature of the processor core during the time period; and increasing the reduced fan speed to the current fan speed for the fan when the time period expires as indicated by the timer, or the temperature of the processor core exceeds the predetermined threshold temperature.

Example 18 may include an apparatus for computing, comprising: a printed circuit board (PCB); one or more processor cores disposed on the PCB; a controller disposed on the PCB and coupled to the one or more processor cores to manage an amount of power supplied to a processor core of the one or more processor cores, wherein the processor core operates in a selected one of at least a first operation mode consuming a first power level, and in a second operation mode consuming a second power level higher than the first power level; wherein the controller is arranged to: reduce or cause to be reduced an amount of power supplied to a component of a thermal energy management solution for a time period from a third power level to a fourth power level lower than the third power level, and increase or cause to be increased an amount of power supplied to the processor core for the processor core to operate in the second operation mode at the second power level during but not exceed the time period.

Example 19 may include the apparatus of example 18 and/or some other examples herein, further comprising a common power supply to provide power to the component of the thermal energy management solution, and to provide power to the one or more processor cores.

Example 20 may include the apparatus of example 18 and/or some other examples herein, wherein the controller is further to: determine a temperature of the processor core to be less than a predetermined threshold temperature; determine the processor core is to operate in the second operation mode; and determine a power supply of the processor core is less than a threshold power limit.

Example 21 may include the apparatus of example 18 and/or some other examples herein, wherein the controller is further to reduce or cause to be reduced the amount of power supplied to the processor core, and return the processor core to operate in the first operation mode at the first power level, after the time period.

Example 22 may include one or more non-transitory computer-readable media comprising instructions that cause a controller, in response to execution of the instructions by the controller, to: determine a temperature of a processor core of a computing platform to be less than a predetermined threshold temperature, wherein the processor core operates in a selected one of at least a first operation mode consuming a first power level, and in a second operation mode consuming a second power level higher than the first power level; determine the processor core is to operate in the second operation mode; determine a power supply of the processor core is less than a threshold power limit; reduce or cause to be reduced an amount of power supplied to a component of a thermal energy management solution of the computing platform for a time period from a third power level to a fourth power level lower than the third power level, and increase or cause to be increased an amount of power supplied to the processor core for the processor core to operate in the second operation mode at the second power level during but not exceed the time period.

Example 23 may include the one or more non-transitory computer-readable media of example 22 and/or some other examples herein, wherein the instructions further causes the controller, in response to execution of the instructions by the controller, to: reduce or cause to be reduced the amount of power supplied to the processor core; and return the processor core to operate in the first operation mode at the first power level, after the time period.

Example 24 may include the one or more non-transitory computer-readable media of example 22 and/or some other examples herein, wherein the instructions causes the controller to determine the processor core is to operate in the second operation mode, in response to a request from the processor core to operate in the second operation mode.

Example 25 may include the one or more non-transitory computer-readable media of example 22 and/or some other examples herein, wherein a sum of the power levels provided to the component of the thermal energy management solution, and the processor core is below a predetermined power budget, wherein the predetermined power budget is measured by at least one of running average power limit (RAPL), maximum allowable instantaneous power (Pmax), or processor thermal design power (TDP).

Example 26 may include an apparatus comprising: means for determining a temperature of a processor to be less than a predetermined threshold temperature; means for determining whether the processor is to operate in a turbo mode; means for reducing the power for thermal energy management solution during a time period from a first power level to a second power level, e.g., reducing a speed of fans of the computing system; means for operating the processor in a turbo mode during the time period; and means for returning the power supply to thermal energy management solution to the first power level when the time period expires.

Example 27 may include an apparatus comprising means to perform one or more elements of a method described in or related to any of examples herein, or any other method or process described herein.

Example 28 may include one or more non-transitory computer-readable media comprising instructions to cause an electronic device, upon execution of the instructions by one or more processors of the electronic device, to perform one or more elements of a method described in or related to any of examples herein, or any other method or process described herein.

Example 29 may include an apparatus comprising logic, modules, or circuitry to perform one or more elements of a method described in or related to any of examples herein, or any other method or process described herein.

Example 30 may include a method, technique, or process as described in or related to any of examples herein, or portions or parts thereof.

Example 31 may include an apparatus comprising: one or more processors and one or more computer readable media comprising instructions that, when executed by the one or more processors, cause the one or more processors to perform the method, techniques, or process as described in or related to any of examples herein, or portions thereof.

Example 32 may include a signal as described in or related to any of examples herein, or portions or parts thereof.

Example 33 may include a signal in a wireless network as shown and described herein.

Example 34 may include a method of communicating in a wireless network as shown and described herein.

Example 35 may include a system for providing wireless communication as shown and described herein.

Example 36 may include a device for providing wireless communication as shown and described herein.

Although certain embodiments have been illustrated and described herein for purposes of description this application is intended to cover any adaptations or variations of the embodiments discussed herein. Therefore, it is manifestly intended that embodiments described herein be limited only by the claims.

What is claimed is:

1. An apparatus for managing computing power of a computing platform, comprising:
a controller disposed in the computing platform to manage an amount of power supplied to a processor core of the computing platform, wherein the processor core operates in a selected one of at least a first operation mode consuming a first power level, and in a second operation mode consuming a second power level higher than the first power level;
wherein the controller is arranged to:
reduce or cause to be reduced an amount of power supplied to a component of a thermal energy management solution for a time period from a third power level to a fourth power level lower than the third power level, and
increase or cause to be increased an amount of power supplied to the processor core for the processor core to operate in the second operation mode at the second power level during but not exceed the time period.

2. The apparatus of claim 1, wherein the time period is in a range of about 1 microsecond to about 10 second.

3. The apparatus of claim 1, wherein the second operation mode of the processor core provides improved computational performance for a bursty workload on the processor core.

4. The apparatus of claim 1, wherein the thermal energy management solution includes a fan, a heat pipe, or a liquid coolant selected from water, ammonia, or freon, and wherein the amount of power supplied to the component of the thermal energy management solution is reduced by reducing a speed of the fan, an amount of flow of a fluid through the heat pipe, or an amount of flow of the liquid coolant.

5. The apparatus of claim 1, further comprising:
one or more processor cores; and
the thermal energy management solution.

6. The apparatus of claim 1, further comprising one or more processor cores; one or more components of the thermal energy management solution; one or more printed circuit boards having the one or more processor cores and the controller disposed thereon, and a mechanical component selected from a container, a cage, a rack, or a chassis enclosing the one or more processor cores, the one or more components of the thermal energy management solution, the controller, and the one or more printed circuit boards.

7. The apparatus of claim 6, further comprising a common power supply to provide power to the one or more components of the thermal energy management solution, and to provide power to the one or more processor cores.

8. The apparatus of claim 6, further comprising a first power supply to provide power to the one or more components of the thermal energy management solution, and a second power supply to provide power to the one or more processor cores.

9. The apparatus of claim 1, wherein a sum of the power levels provided to the component of the thermal energy management solution, and to the processor core is below a predetermined power budget, wherein the predetermined power budget is measured by at least one of running average power limit (RAPL), maximum allowable instantaneous power (Pmax), or processor thermal design power (TDP).

10. The apparatus of claim 1, wherein the computing platform is to operate up to 2100W, and a processor thermal design power for the processor core is selected one of 145W, 205W, or 300W.

11. The apparatus of claim 1, wherein before increasing the amount of power supplied to the processor core, the controller is further to:
determine a temperature of the processor core to be less than a predetermined threshold temperature;
determine the processor core is to operate in the second operation mode; and
determine a power level supplied to the processor core is less than a threshold power limit.

12. The apparatus of claim 1, wherein the controller is arranged to further reduce or cause to be reduced the amount of power supplied to the processor core, and return the processor core to operate in the first operation mode at the first power level, after the time period.

13. The apparatus of claim 1, wherein the controller is arranged to determine the processor core is to operate in the second operation mode, in response to a request from the processor core to operate in the second operation mode.

14. The apparatus of claim 1, further comprising:
a register to store an indicator to allow or disallow the controller to reduce or cause to reduce the amount of power supplied to the component of the thermal energy management solution, and to increase the amount of power supplied to the processor core.

15. The apparatus of claim 1, wherein to reduce or cause to reduce an amount of power supplied to the component of the thermal energy management solution, the controller adjusts, based at least in part on a fan control mechanism, a speed of a fan of the thermal energy management solution.

16. The apparatus of claim 15, wherein the fan control mechanism includes:
determining a temperature of the processor core to be less than a predetermined threshold temperature;
determining a current fan speed of the fan of the thermal energy management solution;
determining a reduced fan speed to maintain the temperature of the processor core to be less than the predetermined threshold temperature; and
decreasing the current fan speed of the fan to the reduced fan speed for the time period during which the amount of power supplied to the fan is reduced, and the amount of power supplied to the processor core is increased.

17. The apparatus of claim 16, wherein the fan control mechanism further includes:
monitoring the time period by a timer;
monitoring the temperature of the processor core during the time period; and
increasing the reduced fan speed to the current fan speed for the fan when the time period expires as indicated by the timer, or the temperature of the processor core exceeds the predetermined threshold temperature.

18. An apparatus for computing, comprising:
a printed circuit board (PCB);
one or more processor cores disposed on the PCB;
a controller disposed on the PCB and coupled to the one or more processor cores to manage an amount of power supplied to a processor core of the one or more processor cores, wherein the processor core operates in a selected one of at least a first operation mode consuming a first power level, and in a second operation mode consuming a second power level higher than the first power level;
wherein the controller is arranged to:
reduce or cause to be reduced an amount of power supplied to a component of a thermal energy management solution for a time period from a third power level to a fourth power level lower than the third power level, and
increase or cause to be increased an amount of power supplied to the processor core for the processor core to operate in the second operation mode at the second power level during but not exceed the time period.

19. The apparatus of claim 18, further comprising a common power supply to provide power to the component of the thermal energy management solution, and to provide power to the one or more processor cores.

20. The apparatus of claim 18, wherein the controller is further to:
determine a temperature of the processor core to be less than a predetermined threshold temperature;
determine the processor core is to operate in the second operation mode; and
determine a power supply of the processor core is less than a threshold power limit.

21. The apparatus of claim 18, wherein the controller is further to reduce or cause to be reduced the amount of power supplied to the processor core, and return the processor core to operate in the first operation mode at the first power level, after the time period.

22. One or more non-transitory computer-readable media comprising instructions that cause a controller, in response to execution of the instructions by the controller, to:
determine a temperature of a processor core of a computing platform to be less than a predetermined threshold temperature, wherein the processor core operates in a selected one of at least a first operation mode consuming a first power level, and in a second operation mode consuming a second power level higher than the first power level;
determine the processor core is to operate in the second operation mode;
determine a power supply of the processor core is less than a threshold power limit;
reduce or cause to be reduced an amount of power supplied to a component of a thermal energy management solution of the computing platform for a time period from a third power level to a fourth power level lower than the third power level, and
increase or cause to be increased an amount of power supplied to the processor core for the processor core to operate in the second operation mode at the second power level during but not exceed the time period.

23. The one or more non-transitory computer-readable media of claim 22, wherein the instructions further causes the controller, in response to execution of the instructions by the controller, to:
reduce or cause to be reduced the amount of power supplied to the processor core; and
return the processor core to operate in the first operation mode at the first power level, after the time period.

24. The one or more non-transitory computer-readable media of claim 22, wherein the instructions causes the controller to determine the processor core is to operate in the second operation mode, in response to a request from the processor core to operate in the second operation mode.

25. The one or more non-transitory computer-readable media of claim 22, wherein a sum of the power levels provided to the component of the thermal energy management solution, and the processor core is below a predetermined power budget, wherein the predetermined power budget is measured by at least one of running average power limit (RAPL), maximum allowable instantaneous power (Pmax), or processor thermal design power (TDP).
